(19) United States
(12) Patent Application Publication
(10) Pub. No.: US 2017/0241292 A1
(43) Pub. Date: Aug. 24, 2017

(54) TURBOMACHINE BLADE, COMPRISING A ROOT WITH REDUCED STRESS CONCENTRATIONS

(71) Applicant: SAFRAN AIRCRAFT ENGINES, Paris (FR)

(72) Inventors: Guillaume PEREZ, Combs La Ville (FR); Laurent Donatien Behaghel, Neuville Sur Saone (FR); Guillaume Brun, Chilly-Mazarin (FR); Matthieu Loger, Orly (FR); Arnaud Sanchez, Quincy-Sous-Senart (FR)

(73) Assignee: SAFRAN AIRCRAFT ENGINES, Paris (FR)

(21) Appl. No.: 15/435,781

(22) Filed: Feb. 17, 2017

(30) Foreign Application Priority Data
Feb. 19, 2016 (FR) 16 51386

(51) Int. Cl. F01D 25/24; F01D 9/04

(52) U.S. Cl. CPC F01D 25/243; F01D 9/041; F05D 2220/32; F05D 2240/122; F05D 2260/31; F05D 2260/94

(57) ABSTRACT

The flange (11) of a blade root platform (10) is separated from an adjacent edge (31) of the blade (4) by a groove (18), that prevents direct transmission of forces created by the bolted attachment of the platform flange (11) to the adjacent part of the blade (4) and reduces stress concentrations.

The subject of the invention is a turbomachine blade comprising a root with reduced stress concentrations.

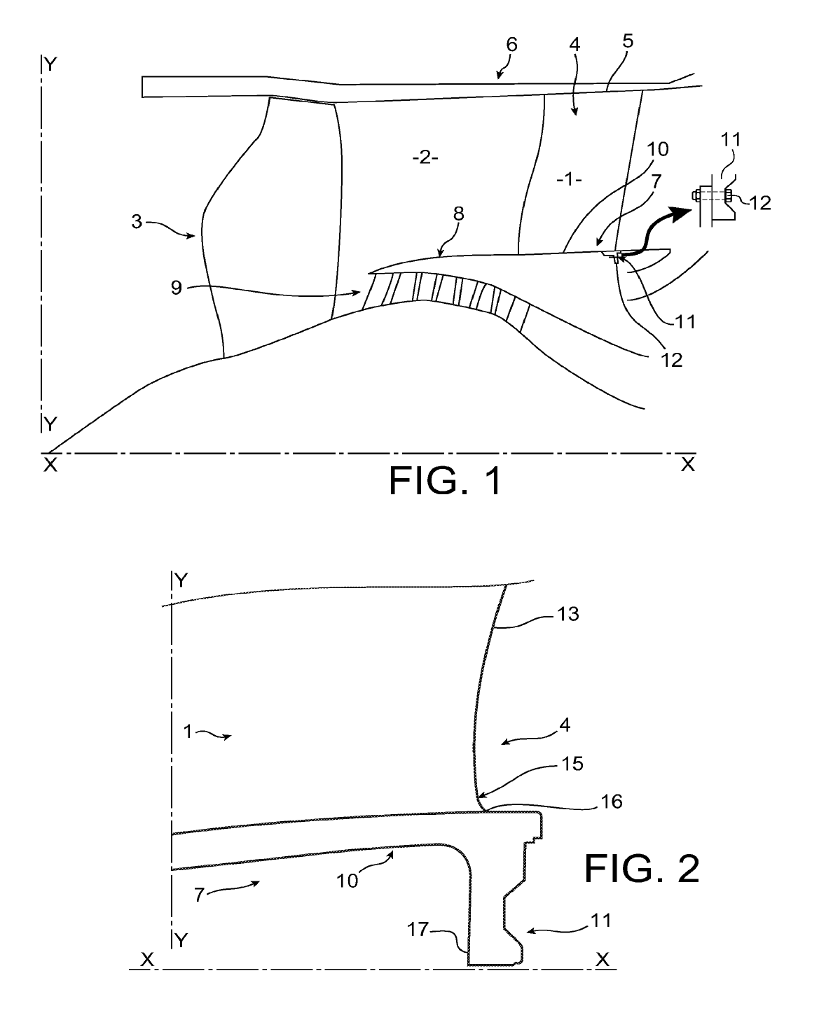

Some turbomachine blades, one example of which is represented in FIG. 1, include the following arrangement. It is a fixed flow guide vane in an outer flow stream 2 of a twin-spool turbomachine 2 downstream from a fan 3, but other categories of vanes, or by extension other turbomachine arms (particularly radial), could be fitted with the invention.

The blade 1 comprises an airfoil 4 passing through the outer flow stream 2, a head end 5 bolted to an outer casing 6 and the other end, a root 7 connected to an inner casing 8 separating the outer flow stream 2 from the inner flow stream 9. The root 7 comprises a platform 10 for which the main extension direction is parallel or almost parallel to the X-X axial direction of the turbomachine, extends over a section of a circle, and it also comprises a flange 11 at one end 34 (in this case a downstream end) of the platform 10 along the X-X direction, that is fixed to the inner case 8 by bolts 12 (the invention would still be applicable if the flange were fitted to the outer case 6). The blade 1 is a single piece, the airfoil 4 being directly connected to the platform 10. FIG. 2 is an enlargement of a zone located behind the blade 1 containing a better view of the flange 11 and the parts adjacent to it, namely one end of the platform 10 and a portion of the airfoil 4, limited by the trailing edge of the airfoil. This region of the blade 1 is subjected to high stress concentrations that can compromise its fatigue strength. These stress concentrations appear especially in a zone 15 of the blade 4, adjacent to the connection 16 of the leading edge 13 with the platform 10, with a single piece structure of the blade 1. Another significant stress concentration zone is observed at the free end 17 of the flange 11, furthest from the platform 10 along the Y-Y radial direction of the turbomachine.

The purpose of the invention is to attenuate these stress concentrations. This is achieved by means of a turbomachine blade comprising an airfoil and a root, the root including a platform and a flange through which bolt holes are formed for bolting to a case of the turbomachine, the airfoil and the flange forming a single piece with the platform and extending along opposite directions from the platform along a radial direction (Y-Y) of the turbomachine, the airfoil comprising an edge connected to the platform, the platform extending from one end along an essentially axial direction (X-X) of the turbomachine, characterised in that the root comprises a groove extending from said end, between the platform and the flange and penetrating in said essentially axial direction towards a bottom beyond a connection point of said edge of the airfoil and the platform and beyond the entire flange; said connection point of the edge of the airfoil and the platform is located along said essentially axial direction (X-X), between said end of the platform and at least one face of the flange facing said end; the flange being connected to the platform by a neck delimited by a face of the groove and extending mainly along said essentially axial direction (X-X) from the flange to the heel, and having a thickness less than the minimum thickness of the flange.

Note that several documents (EP 1 811 131 A2, DE 10 2004004014 A1, U.S. Pat. No. 5,669,759 A, WO 2008 115390 A1 and WO 2009 115384 A1) disclose blade roots notched at one end, in front of an edge of the airfoil, to reduce stress concentrations; but these devices either do not have a bolting flange, or the connection of the edge to the root is not brought closer to the end than the flange, or the groove does not extend beyond the flange, or the flange is not connected to the root by a thinned neck.

The invention is based on the observation that stress concentrations are explained especially by direct transmission of forces produced by the attachment of blade 1 and that appear in the flange 11. The essential purpose of the groove is to eliminate the direct communication between the zone 15 of the airfoil 4 adjacent to both the edge 13 and to the root 7, and the flange 11. The zone 15, then being close to a much more flexible portion of the blade 1, is relieved; forces that were responsible for the stress concentration are transmitted to other parts of the blade 1, without causing the development of any important stress concentrations.

All the characteristics described above contribute more specifically to making a more sinuous stress path between the end of the airfoil, its connection to the root platform, and bolted attachments of the flange to give better resistance (in this precise configuration with two highly loaded zones 15 and 17) to direct transmission of forces between highly stressed regions of the flange and the connection between the airfoil and the root, and thus reduce stress concentrations; and the flexibility of the neck is such that the flange can deflect more easily and further reduce stress concentrations due to the flexibility obtained.

Some improvements to this basic design can reinforce the flexibility of the arrangement and further reduce stress concentrations to critical zones; this is the case particularly if the platform comprises a heel, corresponding to a thickening of the platform in the radial direction, extending beyond the bottom of the groove along the essentially axial direction, the neck connecting the heel to the flange.

Note that the invention is perfectly applicable to arrangements in which the flange comprises a thinned central portion between two concentric conical portions, the central portion being drilled with bolt holes, the conical bearing surfaces facing the end of the platform.

According to other improvements, also reducing local stress concentrations in this case: the flange is connected to the heel by a rounded surface; or the groove opens up towards said end of the platform and is delimited by two faces converging towards the bottom, and the bottom is formed by a rounded surface joining said faces.

The airfoil edge concerned may be the trailing edge, for example as in FIGS. 1 and 2, or the leading edge of the airfoil; however problems are usually more severe with the trailing edge, since the airfoil is thinner near this edge.

We will now give a complete description of a particular embodiment of the invention, that will be sufficient to clearly understand its different aspects, characteristics and advantages with reference to the following figures:

FIG. 1, already described, represents a blade according to prior art;

FIG. 2 is an enlargement of FIG. 1 showing an end region of the blade platform;

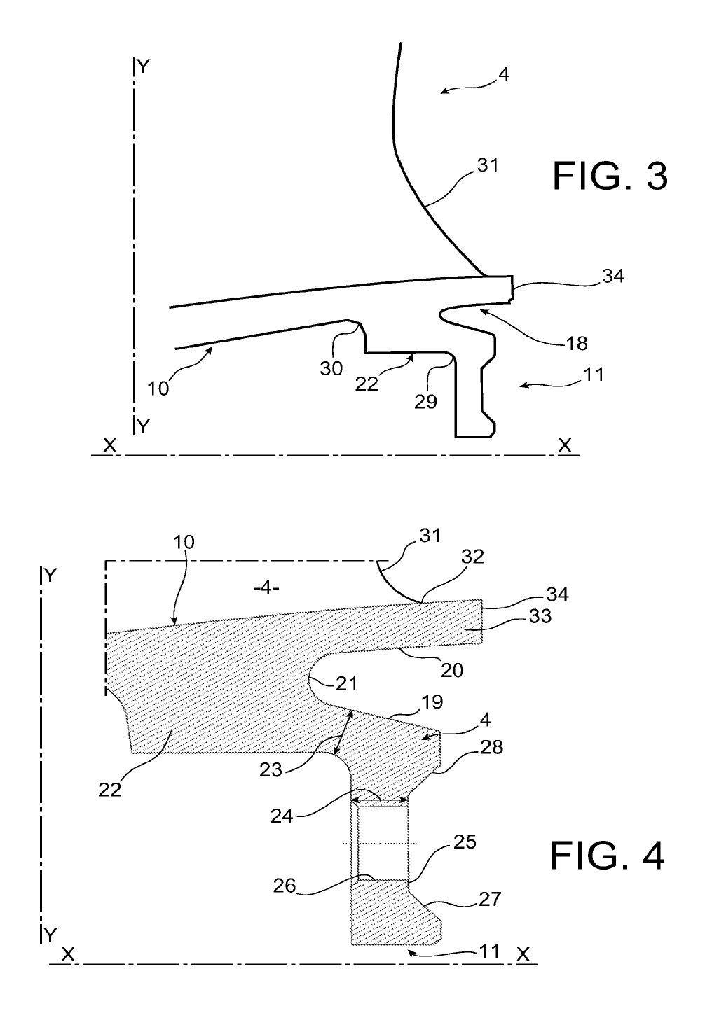

FIG. 3 represents the same region for a blade characteristic of the invention;

FIG. 4 is an enlargement of FIG. 3;

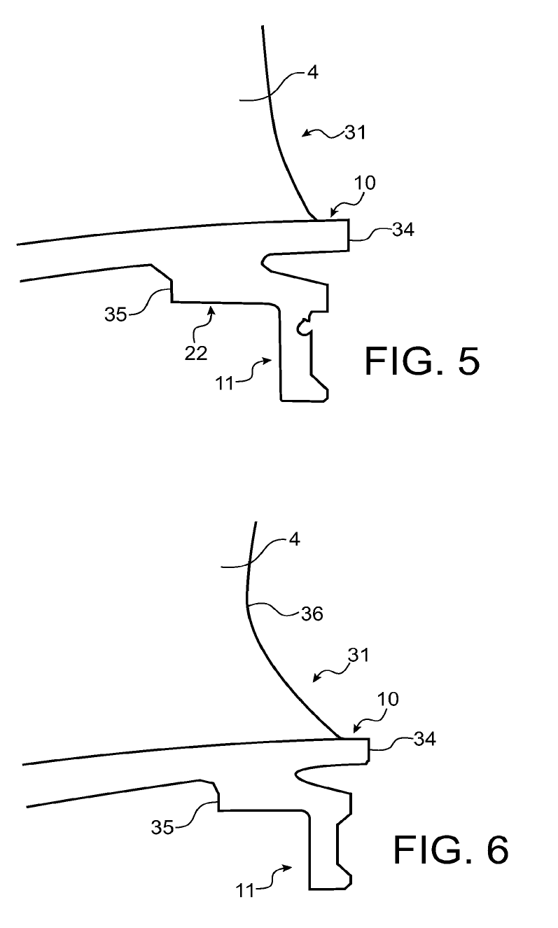

and FIGS. 5 and 6 represent two design variants of the blade.

Refer to FIGS. 3 and 4. Unlike the design shown on FIG. 2, the flange 11 is now separated from the platform 10 by a groove 18. This groove 18 is delimited by a conical face 19 on one side of the flange 11, and another face 20 that is conical or cylindrical as in this case, on the side of the platform 10, the faces 19 and 20 converging towards each other and connecting to each other at a rounded groove bottom 21. The groove 18 is fairly deep, from its opening to the bottom 21, to extend over the entire thickness of the flange 11 and beyond it, and thus to separate it from the airfoil 4 in a radial direction Y-Y of the turbomachine. The bottom 21 extends projecting in the axial direction X-X and in the upstream direction (along the direction of flow of fluid around the blade 1) beyond the connection point 32 of the edge 31 of the airfoil 4 to the platform 10. Upstream from the bottom 21 of the groove 18 in the axial direction X-X, the platform 10 is thickened in the radial direction Y-Y, by a heel 22 that is connected to the flange 11 by a neck 23. The neck 23, delimited by face 19, is less thick than the minimum thickness 24 of the flange 11 (in this case a thinned central portion 25 in which the bolt holes 26 are formed, and limited by two concentric conical bearing surfaces 27 and 28, as is usual for this type of flange). Other rounded parts 29 and 30 are formed on concave fillets between the flange 11 and the heel 22, and between the heel 22 and the platform 10 itself.

Note that unlike usual designs, the edge 31 of the airfoil 4 on the side of the flange 11 is moved towards the end 34 of the platform 10, such that its connection point 32 with the platform 10 extends beyond at least one of the faces of the flange 11 (in this case the face of the thinned central portion 25) that face towards said end 34 along the axial direction X-X.

The flange 11 is mounted flexibly on the platform 10 by the thin neck 23. The corner of the airfoil 4 adjacent to the connection point 32 is also mounted flexibly on the platform 10, the end of which above the groove 18 forms a projection 33 that is also thin on which this corner and therefore the connection point 32 extends. The increased flexibility of the blade 1 at these locations can reduce stress concentrations, by distributing forces towards adjacent areas with lower loads. Therefore it is advantageous if the groove 18 is relatively wide between the faces 19 and 20 to accentuate the flexibility at immediately adjacent locations of the blade 1 (the neck 23 and the projection 33). It is also advantageous if the groove 18 is sufficiently deep to the bottom 21 so that the neck 23 and the projection 33 can be extended with the same effect of increased flexibility, and to make the transmission path of forces between the flange 11 and the corner of the airfoil 4 more sinuous, and thus reduce their magnitude. The heel 22 helps in distributing stresses and therefore reducing their concentration at the end 34 of the airfoil 1; the rounded parts 29 and 30, and the rounded bottom 21, also tend to reduce local stress concentrations.

If the edge 31 of the airfoil 4 is pushed towards the end 34 of the platform 10, its profile from the platform 10 is not critical concerning the reduction of stress concentrations: the layouts in FIGS. 5 and 6 have both given good results in this respect.

Unlike the profile of the trailing edge 13 in FIG. 2 that; starting from the platform 10 and working in a radially outwards direction, bends firstly briefly forwards and then backwards, the profile in FIG. 5 according to the invention bends towards the upstream direction by a height greater than or equal to the distance between the end 34 and an upstream face 35 of the heel 22, with a steep slope in the upstream direction (about 30°) close to the platform 10, and then progressively decreasing; and the profile in FIG. 6, also according to the invention, bends in the upstream direction with a steep (more than 30°) and approximately constant slope over a height equal to approximately the distance between the end 34 and the upstream face 35; and then radially further outwards, it bends slightly in the downstream direction with a shallow slope (about 10°), with a marked inflection point 36 from the previous slope.

1. Turbomachine blade comprising an airfoil (4) and a root (7), the root including a platform (10) and a flange (11) through which bolt holes (26) are formed for bolting to a case (8) of the turbomachine, the airfoil (4) and the flange (11) forming a single piece with the platform (10) and extending along opposite directions from the platform along a radial direction (Y-Y) of the turbomachine, the airfoil comprising an edge (31) connected to the platform, the platform extending from one end (34) along an essentially axial direction (X-X) of the turbomachine, characterised in that the root comprises a groove (18) extending from said end (34), between the platform (10) and the flange (11) and penetrating in said essentially axial direction towards a bottom (21) beyond a connection point (32) of said edge of the airfoil and the platform and beyond the entire flange (11); said connection point of the edge of the airfoil and the platform is located along said essentially axial direction (X-X), between said end (34) of the platform and at least one face (25) of the flange (11) facing said end (34); the flange (11) being connected to the platform by a neck (23) delimited by a face (19) of the groove (18) and extending mainly along said essentially axial direction (X-X) from the flange to the heel, and having a thickness less than the minimum thickness (24) of the flange (11).

2. Blade according to claim 1, characterised in that the platform comprises a heel (22) corresponding to a thickening of the platform (10) in the radial direction, extending beyond the bottom (21) of the groove (18) along the essentially axial direction (X-X), the neck (23) connecting the heel (22) to the flange (11).

3. Blade according to claim 2, characterised in that the flange (11) is connected to the heel (22) through a rounded surface (29).

4. Blade according to claim 1, characterised in that the groove (18) opens up towards said end of the platform and is delimited by two faces (19, 20) converging towards the bottom (21), and the bottom is formed by a rounded surface joining said faces.

5. Blade according to claim 4, characterised in that said faces comprise a cylindrical face (20) delimiting the platform (10) and a conical face (19) delimiting the flange (11).

6. Blade according to claim 1, characterised in that the flange comprises a thinned central portion (25) between two concentric conical bearing surfaces (27, 28), the central portion being drilled with bolt holes (26), the conical bearing surfaces facing said end (34).

7. Blade according to claim 1, characterised in that said edge (31) is a trailing edge of the blade.

8. Blade according to claim 1, characterised in that it is a fixed blade of the turbomachine.
